(19) United States
(12) Patent Application Publication
(10) Pub. No.: US 2003/0156348 A1
(43) Pub. Date: Aug. 21, 2003

(54) Tape pulling-out member in magnetic recording-and-reproducing apparatus

(76) Inventor: Kouji Azai, Fukui (JP)

Correspondence Address: WENDEROTH, LIND & PONACK, L.L.P., 2033 K STREET N. W., SUITE 800, WASHINGTON, DC, 20006-1021, US

(21) Appl. No.: 10/368,393

(22) Filed: Feb. 20, 2003

(30) Foreign Application Priority Data
Feb. 20, 2002 (JP) 2002-43672

(51) Int. Cl. G11B 5/027

(52) U.S. Cl. 360/85

(57) ABSTRACT

Disclosed is an improvement in a tape pulling-out member which can move in a guide slot made in the deck of a magnetic recording-and-reproducing apparatus, thereby pulling a length of recording tape out of the winding or unwinding reel of a tape cassette. The tape pulling-out member comprises a base, an inclined post and a guide roll both rising upright on the base for guiding and directing the length of recording tape fed from the winding or unwinding reel to the rotary drum on the deck of the magnetic recording-and-reproducing apparatus, and a nose formed on the forward end of the base. The nose is so convergent or iron-like in shape that it may be put in linear contact with the opposite sides of the V-shaped end of the guide slot. Thus, the contact area is substantially increased, and accordingly the pressure per unit area of the nose is decreased. Accordingly the wearing quantity of the nose is so reduced that the correct positioning of the tape pulling-out member at the “V”-shaped terminal end of the guide slot may be assured even after it has been used a lot.

### BACKGROUND OF THE INVENTION

1. Field of the Invention

The present invention relates to a part of a magnetic recording-and-reproducing apparatus, and particularly to a tape pulling-out member which can be controlled by a tape loading mechanism to move in a guide slot made in the deck of a magnetic recording-and-reproducing apparatus, thereby pulling a length of recording tape out of the winding or unwinding reel of a tape cassette.

2. Related Art

As is well known, the rotary drum is inclined at a predetermined angle, and is mounted on the deck of a video recorder. When the rotary drum rotates, the length of tape runs together. The length of tape is applied to the rotary drum over approximately 180 degrees. When the rotary drum rotates at a high constant speed, the length of tape runs at a predetermined speed to send and receive signals from the magnetic heads, which are mounted on the circumference of the drum for recording and reproducing signals.

Referring to FIG. 7, the length of tape 2 is applied to the rotary drum 1 on the deck of a video recorder. For applying the length of tape 2 fed from the videocassette 3 to the rotary drum 1 a first stationary post 4, first tension posts 5, first guide roll 6 and first inclined post 7 are arranged on the order named on the tape-feeding side. Likewise, a second inclined post 7, second guide roll 6, pinch roll-and-capstan 8 and 9, and second stationary post 4 are arranged on the order named on the tape-winding side.

In the tape-loading condition as shown in FIG. 7, the length of tape 2 is pulled out of the unwinding reel of the cassette, and is pulled in the winding reel of the cassette via the rotary drum 1. Each pulling-out member runs in the guide slot made on either side of the rotary drum 1 in the deck of the recording-and-reproducing apparatus. The pulling-out member is so designed that it may not shake horizontally or vertically when reaching the terminal end of the guide slot. It is very important to hold the pulling-out member in stable condition at the terminal end of the guide slot because, otherwise, the length of tape cannot be put in correct position relative to the rotary drum, and hence the signals cannot be recorded and reproduced with fidelity.

The applicant filed, on Oct. 16, 1998, a patent application titled “Grip Structure of a Tape Pulling-Out Member in a Magnetic Recording-and-Reproducing Apparatus”, which is useful in putting the length of tape in correct position relative to the rotary drum when the pulling-out member reaches the terminal end of the guide slot. The tape pulling-out member can be controlled by a tape loading mechanism to move in a guide slot made in the deck of a magnetic recording-and-reproducing apparatus, thereby pulling a length of recording tape out of a winding or unwinding reel of a tape cassette. The tape pulling-out member comprises a base, an inclined post and a guide roll both rising upright on the base for guiding and directing the length of recording tape fed from the winding or unwinding reel to the rotary drum on the deck of the magnetic-and-reproducing apparatus, a boss whose width is somewhat smaller than the width of the guide slot to move therein, upper surface slide extensions projecting from the forward side of the base to slide on the upper surface of the deck, detent extensions traversing the guide slot on the rear side of the deck, and a conical projection formed on the forward end of the base. The conical projection is responsive to application of resilient force from the tape loading mechanism for putting its oblique sides in contact with the opposite sides of the “V”-shaped end of the guide slot.

Repetitive abutment and application of the oblique side of the conical projection to the opposite oblique sides of the V-shaped end of the guide slot causes the wearing of the conical projection, thus not allowing the tape pulling-out member to be put in correct position relative to the rotary drum. As a result, the video images cannot be reproduced with high fidelity, and it happens that the length of tape is disordered somewhat, or that the tape cassette cannot be replaced by another one, which if loaded onto the deck, cannot work appropriately. Still disadvantageously the conical projection cannot fully attain its guidance duty at the time of reaching the “V”-shaped terminal end of the guide slot; the tape pulling-out member is apt to deviate apart from the correct position, thus failing to reach same position all the time at the “V”-shaped terminal end.

In view of the above one object of the present invention is to provide a tape pulling-out member capable of self-aligning in posture at the “V”-shaped terminal end, thus putting itself in correct position all the time, and guaranteed to be free of any wearing on its contour.

### SUMMARY OF THE INVENTION

A tape pulling-out member which can be controlled by a tape loading mechanism to move in a guide slot made in the deck of a magnetic recording-and-reproducing apparatus, thereby pulling a length of recording tape out of a winding or unwinding reel of a tape cassette, the tape pulling-out member comprising a base, an inclined post and a guide roll both rising upright on the base for guiding and directing the length of recording tape fed from the winding or unwinding reel to the rotary drum on the deck of the recording-and-reproducing apparatus, and a nose formed on the forward end of the base, is improved according to the present invention in that the nose is so convergent or like an iron in shape that it may be put in linear contact with the opposite sides of the V-shaped end of the guide slot.

A tape pulling-out member which can be controlled by a tape loading mechanism to move in a guide slot made in the deck of a magnetic recording-and-reproducing apparatus, thereby pulling a length of recording tape out of the winding or unwinding reel of a tape cassette, the tape pulling-out member comprising a base, an inclined post and a guide roll both rising upright on the base for guiding and directing the length of recording tape fed from the winding or unwinding reel to the rotary drum on the deck of the recording-and-reproducing apparatus, a boss whose width is somewhat smaller than the width of the guide slot to move therein, upper surface slide extensions projecting from the forward side of the base to slide on the upper surface of the deck, detent extensions traversing the guide slot on the rear side of the deck, and a nose formed on the forward end of the base, is improved according to the present invention in that the nose is so convergent or like an iron in shape that it may be put in linear contact with the opposite sides of the V-shaped end of the guide slot.

The base may have any desired shape, and may be injection-molded from a hard resin material.

The convergent or iron-like form of the nose permits the nose to attain fully its guidance duty, making the tape pulling-out member to be put in correct position even though it comes close to the “V”-shaped terminal end in a wrong direction. Also, the convergent or iron-like form of the nose permits the nose to be put in linear contact with the opposite edges of the “V”-shaped terminal end, thus enlarging the contact area, compared with the point contact in the conventional tape pulling-out member having a conical projection. The convergent nose, therefore, is free of wearing, and it can be injection-molded from a hard resin material. As a matter of course it can be die-casted from metal as usual.

Other objects and advantages of the present invention will be understood from the following description of a tape pulling-out member according to one preferred embodiment of the present invention, which is shown in accompanying drawings.

### BRIEF DESCRIPTION OF THE DRAWING

FIG. 1 illustrates a tape pulling-out member according to the present invention partly in section;

FIGS. 2(a), (b) and (c) show the resin base of the tape pulling-out member as viewed from the front, top and side of the base, respectively;

FIG. 3 illustrates the tape pulling-out members at the terminal ends of the guide slots;

FIG. 4 illustrates the tape pulling-out members prior to arrival at the terminal ends of the guide slots;

FIGS. 5(a) and (b) show the nose as viewed from the top and one side of the nose;

FIGS. 6(a) and (b) illustrate how the convergent nose and the conical projection are put in contact with the “V”-shaped terminal end of the guide slot in the tape pulling-out member of the present invention;

FIGS. 7(a) and (b) illustrate how the convergent nose and the conical projection are put in contact with the “V”-shaped terminal end of the guide slot in the conventional tape pulling-out member; and

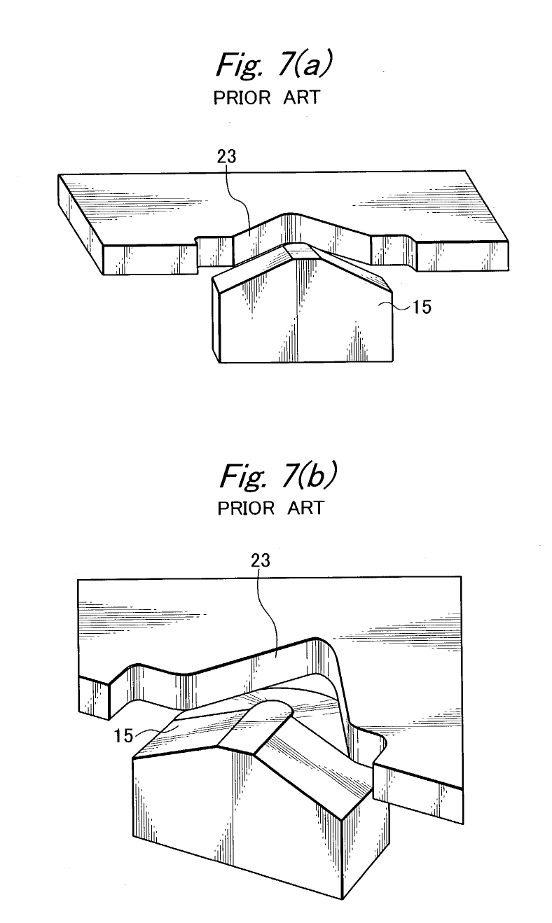

FIG. 8 is a top view of the deck of a video recorder, showing the course on which a length of tape follows.

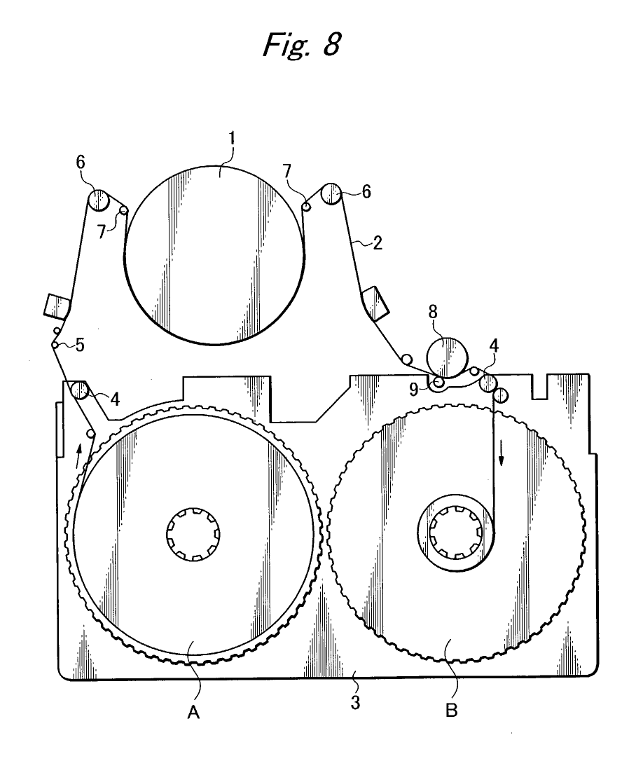

### DETAILED DESCRIPTION OF PREFERRED EMBODIMENT

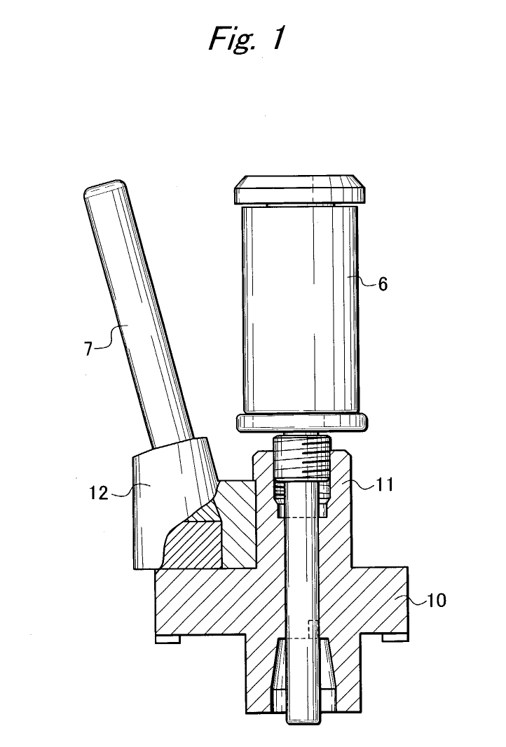

Referring to FIG. 1, a tape pulling-out member according to the present invention comprises a guide roll 6, an inclined post 7 and a base 10. The guide roll 6 can freely rotate as a length of recording tape traverses the guide roll 6, and the oblique post 7 is inclined at the same angle as the rotary drum 1. The base 10 is made of a very hard resin, and it has an axle hole made therein. The axle 12 of the guide roll 6 is press-fitted into the axle hole 13 of the base 10, and likewise, the inclined post 7 is press-fitted into the post hole 21 of the base 10. The tape pulling-out member is similar to the conventional tape guide in appearance.

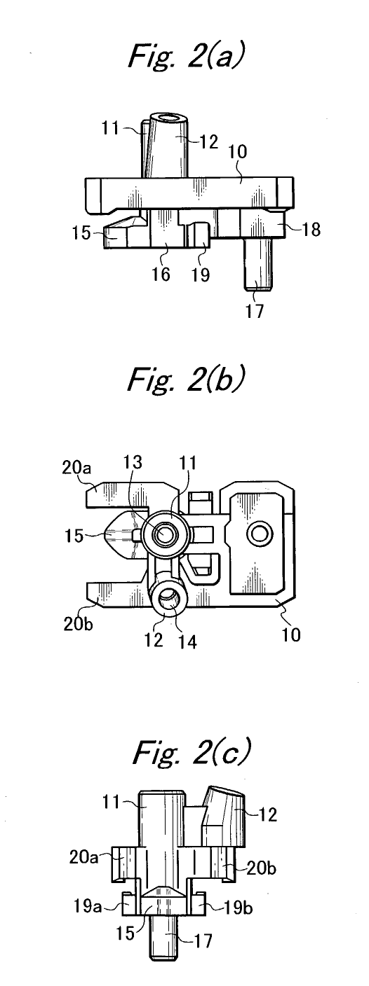

Referring to FIG. 2, the resin base 10 is an injection-molded article, and it has two cylindrical projections 11 and 12 formed on its upper surface. The axle hole 13 is made in the upright projection 11 for press-fitting the axle of the guide roll 6 whereas the post hole 14 is made in the inclined projection 12 for press-fitting the inclined post 7. A nose 15 is formed on the forward end of the base 10.

As seen from FIG. 2, the base 10 has a boss 16 projecting from its bottom, and the axle hole 13 extends from the upright projection 11 to pass through the boss 16. The axle of the guide roll 6 is press-fitted in the axle hole 13. Also, the base 10 has another boss 18 projecting from its bottom. These bosses 16 and 18 are slidably fitted in each guide slot so that the tape pulling-out member may move in the guide slot. The base 10 has detents 19a and 19b traversing the guide slot on the rear side of the deck of the video recorder. These detents 19a and 19b can slide on the rear surface of the deck of the video recorder.

The base 10 has a “U”-shaped extension formed on its forward end, and its two arms 20a and 20b are put on both sides of the guide slot. The base 10 has small projections formed on its bottom, rear side, and formed on the bottoms of the arms 20a and 20b, thereby reducing the friction between the bottom of the base 10 and the upper surface of the deck of the video recorder. Likewise, the detents 19a and 19b have small projections formed on their upper surfaces, thereby reducing the friction between the upper surfaces of the detents and the lower surface of the deck of the video recorder.

The iron-like nose 15 is formed on the bottom, forward end of the base 10, extending between the opposite arms 20a and 20b. When the tape pulling-out member reaches the terminal end of the guide slot, the tape recorder is loaded with the length of magnetic tape, and then, the resilient force is applied to the base 10 via the pin 17 so that the iron-like nose 15 is pushed against the opposite edges of the “V”-shaped end, thus putting the tape pulling-out member in correct position.

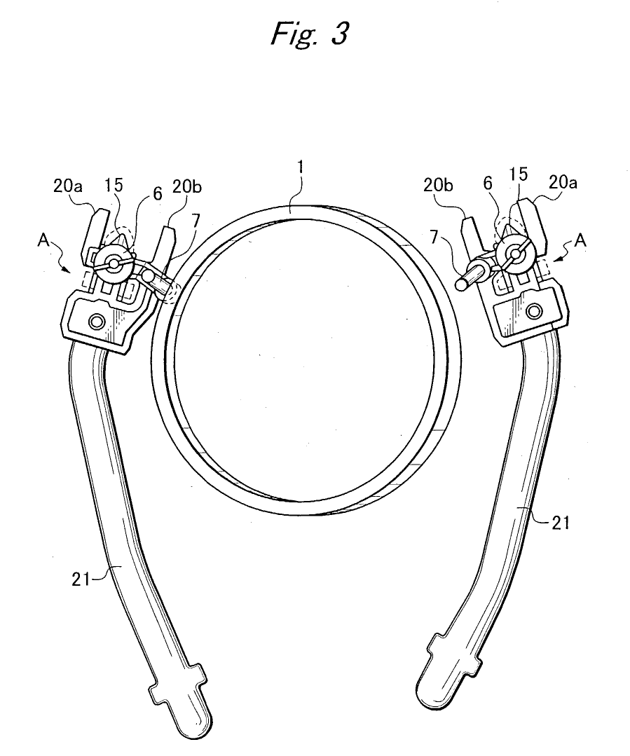

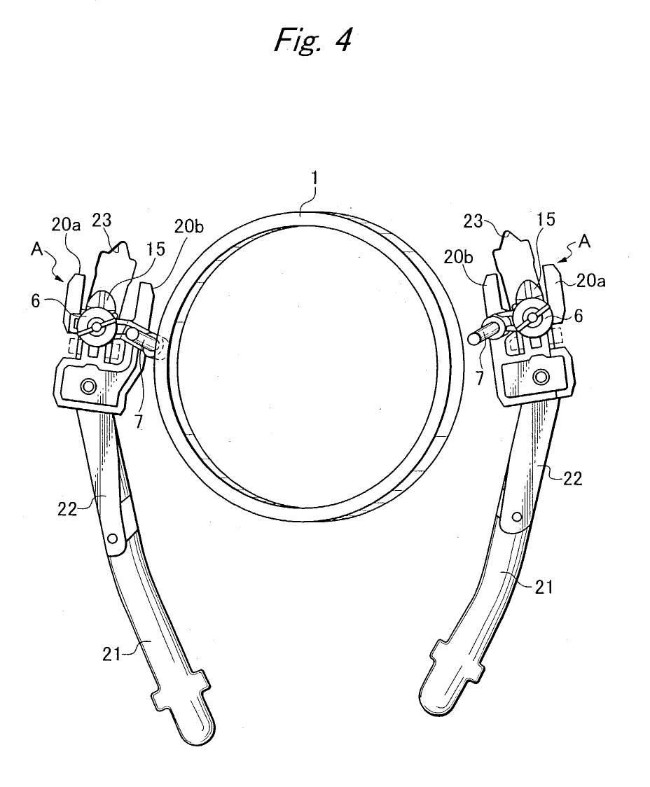

FIG. 3 shows that the tape pulling-out member A is put in the loading finish position whereas FIG. 4 shows that the tape pulling-out member A is on the way to the loading finish position. The tape pulling-out member A is movably fitted in the guide slot 21, and it can be driven by the tape loading mechanism so that it may pull a length of tape out of the winding or unwinding reel of the tape cassette 3 to direct to the rotary drum 1 via the guide roller 6 and inclined post 7. The loading arm 22 of the tape pulling-out member A is actuated by the loading motor (not shown), and the loading arm 22 works together with the pin 7 of the tape pulling-out member A to control the tape pulling-out member A, and at the terminal end of the guide slot the loading arm 22 is spring-biased to push the iron-like nose 15 against the “V”-shaped terminal end 23 of the guide slot 21.

Thanks to the bosses 16 and 18 fitted in the guide slot 21, and thanks to the arms 20a and 20b and detents 19 sandwiching the deck thickness on both sides of the guide slot 21 the tape pulling-out member A can be put in correct position, in which the length of tape is applied to the rotary drum 1 for recording or reproducing video signals.

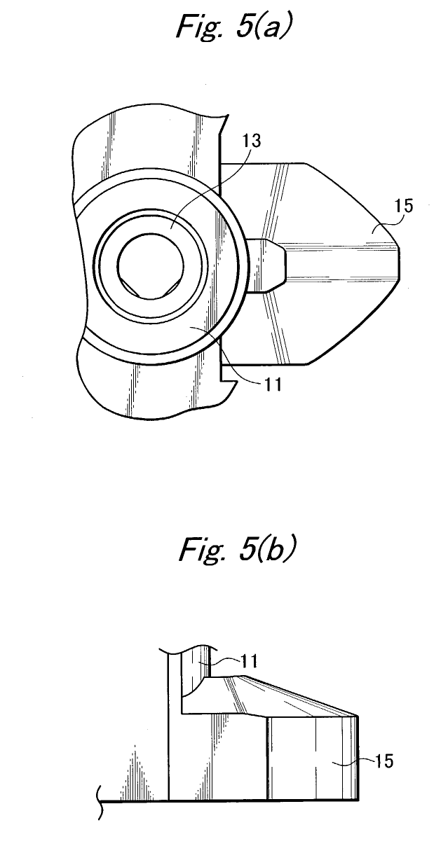

As seen from FIG. 5, the convergent or iron-like nose 15 can be put in linear contact with the opposite sides of the V-shaped end of the guide slot 21. Accordingly the pressure per unit area applied to the convergent nose is substantially reduced, compared with the conventional conical base, which is put in point contact with the opposite sides of the V-shaped end of the guide slot 21. Thanks to the linear contact between the nose and the guide slot wall, the hard resin base is guaranteed to be free of deformation or wearing.

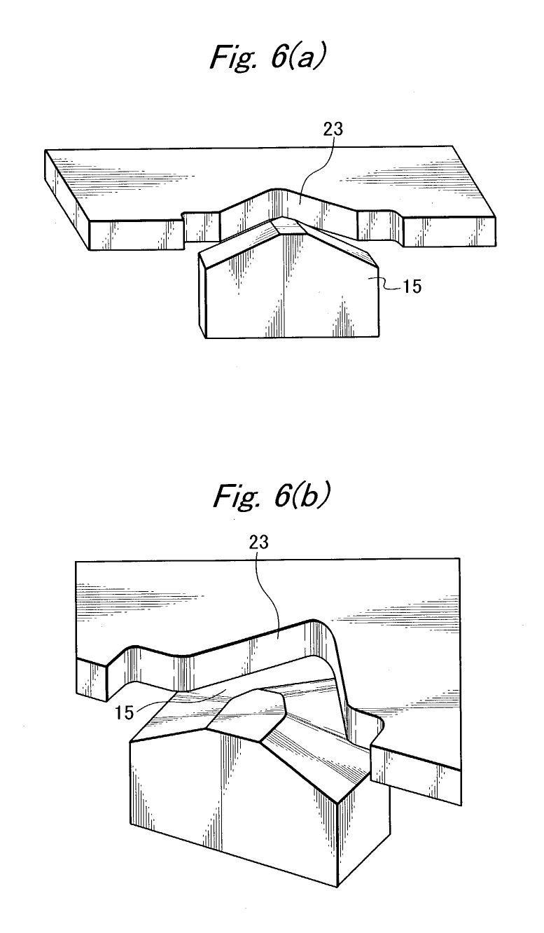

Referring to FIG. 6, the convergent nose fits to the opposite sides of the “V”-shaped terminal end 23 well with its contact area enlarged. The degree of wearing in the convergent nose is much lower than that in the conical nose for one and same quantity of wearing, and accordingly the total length of period for which the tape pulling-out member can be put in correct position at the “V”-shaped terminal end 23 is increased substantially.

As may be understood from the above, the contact area over which the convergent nose and the opposite sides of the “V”-shaped terminal end are put in contact with each other is substantially increased, compared with the conventional conical nose, and accordingly the pressure per unit area of the nose is decreased. This provides the following advantages: the wearing quantity of the nose is so reduced that the correct positioning of the tape pulling-out member at the “V”-shaped terminal end may be assured even after it has been used a lot, or much more often than the conventional conical nose would be so worn and deformed that the tape pulling-out member cannot be put in correct position; and the tape pulling-out member can be injection-molded from a hard resin material rather than metal, accordingly reducing the manufacturing cost.

What is claimed is:

1. A tape pulling-out member which can be controlled by a tape loading mechanism to move in a guide slot made in a deck of a magnetic recording-and-reproducing apparatus, thereby pulling a length of recording tape out of a winding or unwinding reel of a tape cassette, the tape pulling-out member comprising a base, an inclined post and a guide roll both rising upright on the base for guiding and directing the length of recording tape fed from the winding or unwinding reel to a rotary drum on the deck of the magnetic recording-and-reproducing apparatus, and a nose formed on the forward end of the base, wherein the nose is so convergent or iron-like in shape that it may be put in linear contact with the opposite sides of the V-shaped end of the guide slot.

2. A tape pulling-out member which can be controlled by a tape loading mechanism to move in a guide slot made in a deck of a magnetic recording-and-reproducing apparatus, thereby pulling a length of recording tape out of a winding or unwinding tape of a cassette, the tape pulling-out member comprising a base, an inclined post and a guide roll both rising upright on the base for guiding and directing the length of recording tape fed from the winding or unwinding reel to a rotary drum on the deck of the magnetic recording-and-reproducing apparatus, a boss whose width is somewhat smaller than the width of the guide slot to move therein, upper surface slide extensions projecting from the forward side of the base to slide on the upper surface of the deck, detent extensions traversing the guide slot on the rear side of the deck, and a nose formed on the forward end of the base, wherein the nose is so convergent or iron-like in shape that it may be put in linear contact with the opposite sides of the V-shaped end of the guide slot.

3. A tape pulling-out member according to claim 1 or 2, wherein the base is injection-molded from a hard resin material.
